(19) United States
(12) Patent Application Publication
(10) Pub. No.: US 2018/0264567 A1
(43) Pub. Date: Sep. 20, 2018

(54) SANDER FOR FOAM PRODUCTS

(71) Applicant: JOHN L. NAU, Fairbanks, AK (US)

(72) Inventor: JOHN L. NAU, Fairbanks, AK (US)

(21) Appl. No.: 15/461,734

(22) Filed: Mar. 17, 2017

(51) Int. Cl. B23D 71/04; B23D 73/04; E04F 13/04; E04F 21/00; E04B 1/76

(52) U.S. Cl. CPC B23D 71/04; B23D 73/04; E04B 1/762; E04F 21/00; E04F 13/04

(57) ABSTRACT

A hand rasp tool for sanding foam surfaces includes a frame having a bottom, a first end, and a second end. The tool further includes a rasp grating attached to the bottom of the frame between the first end and the second end, the rasp grating including multiple scraping teeth. The tool also includes a first shoe, having a bottom surface, attached to the first end of the frame and a second shoe, having a bottom surface, attached to the second end of the frame. The bottom surface of the first shoe and the bottom surface of the second shoe are coplanar with a tip of each of the multiple scraping teeth.

### FIELD OF THE DISCLOSURE

This disclosure is related generally to sanding structural surfaces, and more particularly to a sander for foam products.

### BACKGROUND

Exterior insulation finishing system (EIFS) foam is often used in building design to provide exterior walls with an insulated, water-resistant, finished surface. During construction EIFS foam may be applied to a building or structure as panels using an adhesive. After installation, however, there may be inconsistencies, bumps, or recessions in the EIFS foam wall.

Typical methods for smoothing an EIFS foam surface include using a hand rasp tool for sanding and periodically checking the surface with a level to determine whether additional sanding is required and where to sand. This process can be time consuming and may cause delays in large scale construction projects. Further, sanding using a hand rasp tool requires great skill as applying too much pressure to the tool, or holding the tool at a wrong angle, may damage the sanding surface, resulting in the need to replace one or more portions of the EIFS foam. Other disadvantages may exist.

### SUMMARY

The present disclosure is directed to an apparatus, method, and/or system that overcomes some of the problems and disadvantages discussed above. Disclosed is a hand rasp tool that performs automatic leveling functions due to shoes located on either side of the tool. The shoes contact a surface to be sanded and provide a guide for a rasp grating. As the tool is systematically moved along the surface, the shoes eventual pass into recessions within the surface and the rasp grating removes excess material from the surface, thereby flattening the surface to the level of the recession.

In an embodiment, a hand rasp tool for sanding foam surfaces includes a frame having a bottom, a first end, and a second end. The tool further includes a rasp grating attached to the bottom of the frame between the first end and the second end, the rasp grating including multiple scraping teeth. The tool also includes a first shoe, having a bottom surface, attached to the first end of the frame and a second shoe, having a bottom surface, attached to the second end of the frame. The bottom surface of the first shoe and the bottom surface of the second shoe are coplanar with a tip of each of the multiple scraping teeth.

In some embodiments, the frame is formed from an extruded metal. In some embodiments, the metal is selected from a group consisting of aluminum, steel, and titanium. In some embodiments, the frame is formed from a molded plastic. In some embodiments, the multiple scraping teeth of the rasp grating are formed from a material selected from a group consisting of punched sheet metal, grit particles, and molded plastic. In some embodiments, the rasp grating is removable and interchangeable with a second rasp grating, the second rasp grating including multiple scraping tips. In some embodiments, the multiple scraping tips of the rasp grating are longer and more sparsely located than the multiple scraping tips of the second rasp grating. In some embodiments, the tool further includes at least one handle coupled to the frame.

In an embodiment, a method of forming a hand rasp tool for sanding foam surfaces includes providing a frame having a bottom, a first end, and a second end. The method further includes providing a rasp grating attachable to the bottom of the frame between the first end and the second end, the rasp grating including multiple scraping teeth. The method also includes providing a first shoe having a bottom surface, the first shoe being attachable to the first end of the frame. The method includes providing a second shoe having a bottom surface, the second shoe being attachable to the second end of the frame. The bottom surface of the first shoe and the bottom surface of the second shoe are coplanar with a tip of each of the multiple scraping teeth when attached to the first and second end respectively.

In some embodiments, the method includes providing extruded metal to form the frame. In some embodiments, the metal is selected from a group consisting of aluminum, steel, and titanium. In some embodiments, the method includes providing molded plastic to form the frame. In some embodiments, the method includes punching sheet metal to form the rasp grating. In some embodiments, the method includes attaching grit particles to the rasp grating. In some embodiments, the method includes molding plastic to form the rasp grating. In some embodiments, the method includes removing the rasp grating and interchanging the rasp grating with a second rasp grating, the second rasp grating including multiple scraping tips. In some embodiments, the multiple scraping tips of the rasp grating are longer and more sparsely located than the multiple scraping tips of the second rasp grating. In some embodiments, the method includes attaching at least one handle to the frame.

In an embodiment, a hand rasp tool kit for sanding foam surfaces includes a hand rasp tool. The hand rasp tool includes frame having a bottom, a first end, and a second end. The tool further includes a first shoe, having a bottom surface, attached to the first end of the frame, and a second shoe, having a bottom surface, attached to the second end of the frame. The tool kit also includes a first rasp grating configured to attach to the bottom of the frame between the first end and the second end, the first rasp grating including multiple scraping teeth. The bottom surface of the first shoe and the bottom surface of the second shoe are coplanar with a tip of each of the multiple scraping teeth of the first rasp grating when the first rasp grating is attached. The tool kit also includes a second rasp grating, interchangeable with the first rasp grating, configured to attach to the bottom of the frame between the first end and the second end, the second rasp grating including multiple scraping teeth. The bottom surface of the first shoe and the bottom surface of the second shoe are coplanar with a tip of each of the multiple scraping teeth of the second rasp grating when the second rasp grating is attached.

In some embodiments, the multiple scraping tips of the first rasp grating are longer and more sparsely located than the multiple scraping tips of the second rasp grating.

### BRIEF DESCRIPTION OF THE DRAWINGS

FIG. 1 is an isometric view from above of an embodiment of a hand rasp tool for sanding foam surfaces.

FIG. 2 is an isometric view from below of an embodiment of a hand rasp tool for sanding foam surfaces.

FIG. 3 is a top view of an embodiment of a hand rasp tool for sanding foam surfaces.

FIG. 4 is a side view of an embodiment of a hand rasp tool for sanding foam surfaces.

FIG. 5 is a front view of an embodiment of a hand rasp tool for sanding foam surfaces.

FIG. 6 is a cross-section view of an embodiment of a hand rasp tool for sanding foam surfaces.

FIG. 7 is an isometric view of an embodiment of a hand rasp tool for sanding foam surfaces that includes multiple interchangeable rasp gratings.

FIG. 8 is a diagram depicting an embodiment of a rasp grating formed from sheet metal.

FIG. 9 is a diagram depicting an embodiment of a rasp grating formed from grit particles.

FIG. 10 is a diagram depicting an embodiment of a rasp grating formed from hardened plastic.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the disclosure.

### DETAILED DESCRIPTION

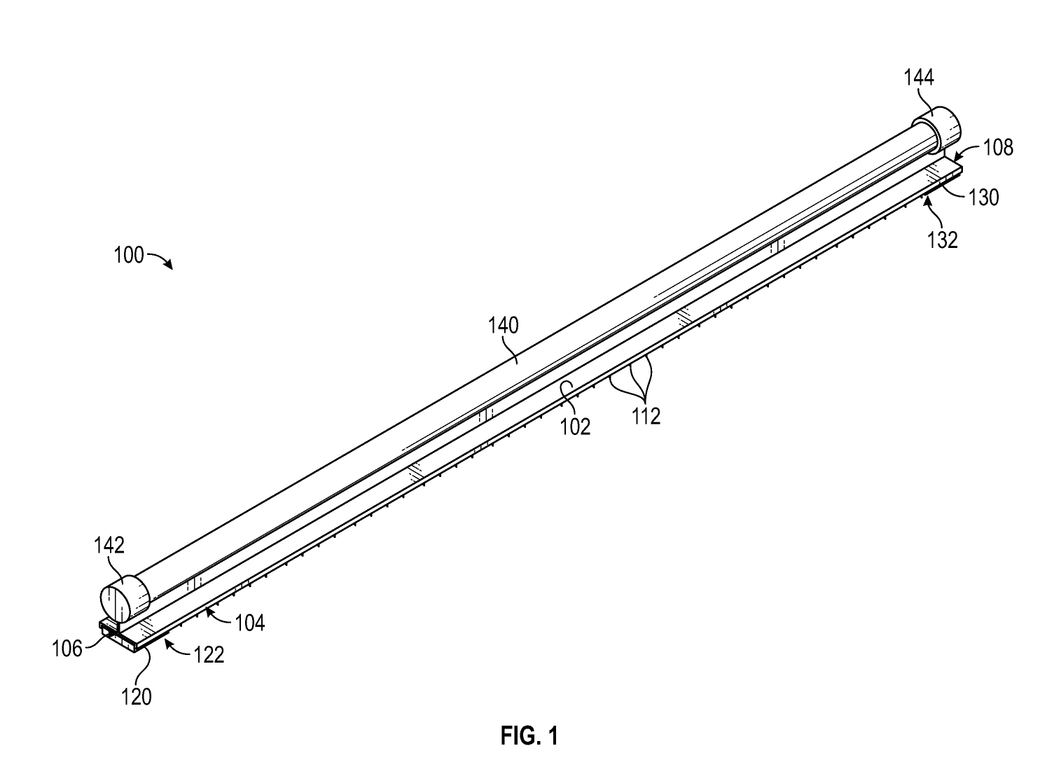

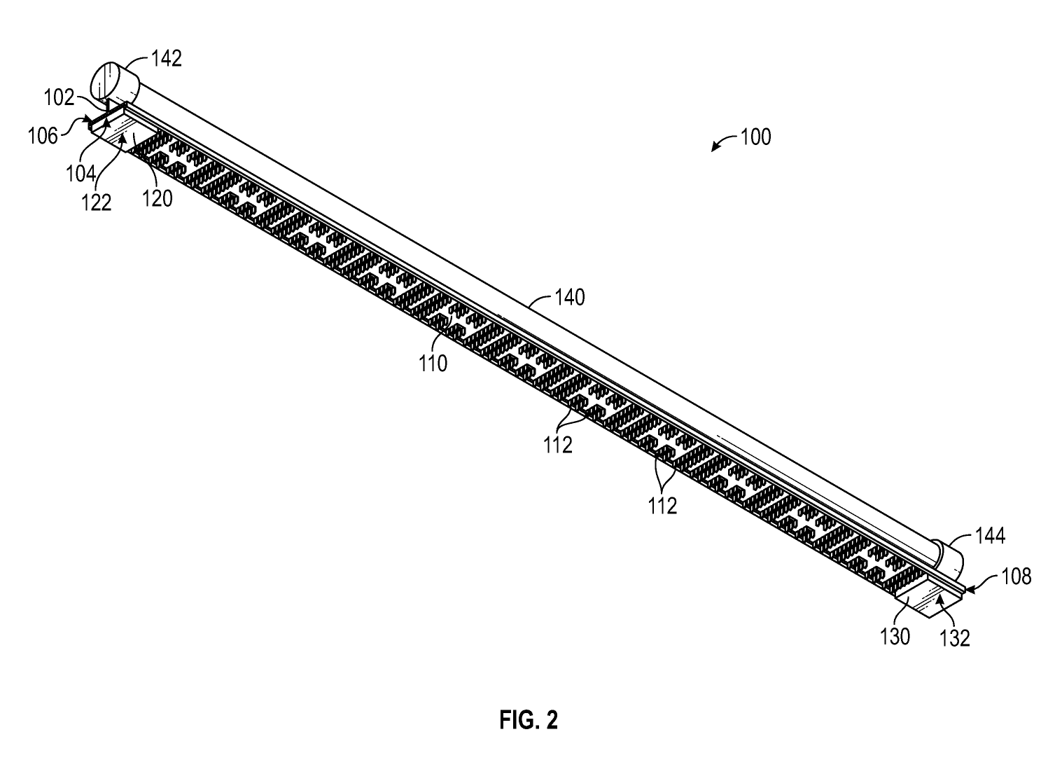

Referring to FIGS. 1 and 2, an embodiment of a hand rasp tool 100 for sanding foam surfaces is depicted. For example, the hand rasp tool 100 may be used for finishing EIFS foam surfaces during the construction of buildings. The tool 100 may include a frame 102, a rasp grating 110, a first shoe 120, a second shoe 130, and a handle 140.

The frame 102 may provide a base for the tool 100. As depicted in FIG. 1, it may be in the form of an I-beam with a truncated upper flange encompassed by the handle 140. Other shapes are possible. The frame 102 may have a bottom 104, a first end 106, and a second end 108. The bottom 104 may attach to the rasp grating 110 and may provide support during sanding. In an embodiment, the frame 102 is formed from an extruded metal. The metal may include aluminum, steel, titanium, another suitable metal, or the like. In another embodiment, the frame 102 may be molded from plastic. Any plastic with sufficient strength and durability to provide support for the rasp grating 110 may be sufficient.

The rasp grating 110 may include multiple scraping teeth 112 for sanding a surface. As shown in FIG. 2, the multiple scraping teeth 112 of the rasp grating 110 may be formed from punched sheet metal with the multiple scraping teeth 112 bending downward from the sheet. As a non-limiting illustrative example, the rasp grating 110 may be similar to a mending plate, used in construction to join two beams together. In another embodiment, the multiple scraping teeth 112 may be formed from grit particles. In yet another embodiment, the multiple scraping teeth 112 may be formed from molded plastic. Each of these embodiments are further described herein. Also, in some embodiments, the rasp grating 110 is removable and interchangeable with another rasp grating, as further described herein. This enables different grades of sanding from rough sanding to fine sanding or finishing.

The first shoe 120 may be attached, or otherwise coupled, to the bottom 104 of the frame 102 at the first end 106. The second shoe 130 may be attached, or otherwise coupled, to the bottom 104 of the frame 102 at the second end 108. A bottom 122 of the first shoe 120 may be coplanar with a bottom 132 of the second shoe 130. Likewise, the bottom 122 and the bottom 132 may be coplanar with a tip of each of the multiple scraping teeth 112.

By being coplanar with a tip of each of the multiple scraping teeth 112, when the bottom 122 of the first shoe 120 and the bottom 132 of the second shoe 130 are placed against a sanding surface, a sanding plane may be formed whereby portions of the sanding surface that extend beyond the sanding plane may be grinded down by the multiple scraping teeth 112. As the tool 100 is moved systematically across the sanding surface, the first shoe 120 and the second shoe 130 eventually pass to the lowest points of the sanding surface, thereby causing all the high points to be grinded off to produce a uniformly flat surface. To that end, it should be noted that when the frame 102 is longer, it will produce a more uniform surface. In contrast, if the frame 102 is not long enough to extend across inconsistencies on a sanding surface, then the tool 100 may not be able to flatten the sanding surface. In an embodiment, the frame is approximately 4 feet long, which is sufficient for sanding EIFS foam surfaces on typical construction projects. It should be noted that lengths of less than about 1 shoe would likely not be sufficient for the intended purpose as inconsistencies in EIFS foam surfaces are typically larger.

In some embodiments, the first shoe 120 and the second shoe 130 may be made of an acrylic or plastic material. In other embodiments, the first shoe 120 and the second shoe 130 may be made of a metal material. It should be noted that the term attached, as used herein, is intended to include embodiments where the first shoe 120, the second shoe 130, and the frame 102 are formed or molded as a single component.

The handle 140 may be attached to the frame 102 and may provide an operator with a convenient grip for using the tool 100. A first cap 142 and a second cap 144 may provide a smooth termination for either end of the handle 140. The handle may be formed from any suitable material or may be defined within the frame 102 itself. As a non-limiting illustrative example, the handle 140 may be similar to polyvinyl chloride (PVC) pipe coupled to the frame 102.

A benefit of the tool 100 is that by making the first shoe 120 and the second shoe 130 coplanar with tips of the multiple teeth 112 of the rasp grating 110, the tool 100 may be able to produce a level surface more efficiently and effectively than typical sanding methods which rely on rasp tools without guiding feet 120, 130 and which require periodically checking a sanding surface with a level. Other benefits and advantages may exist.

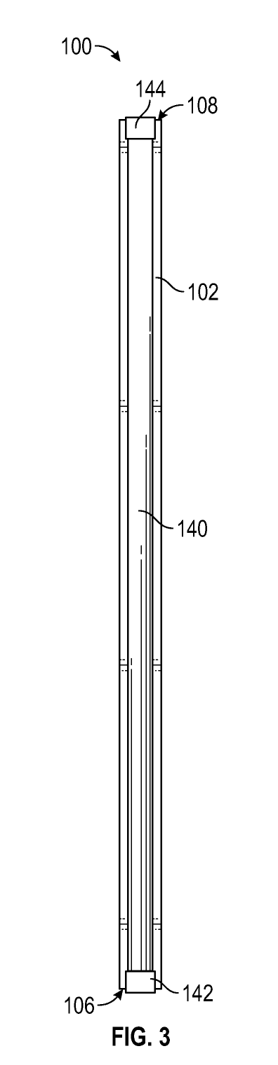

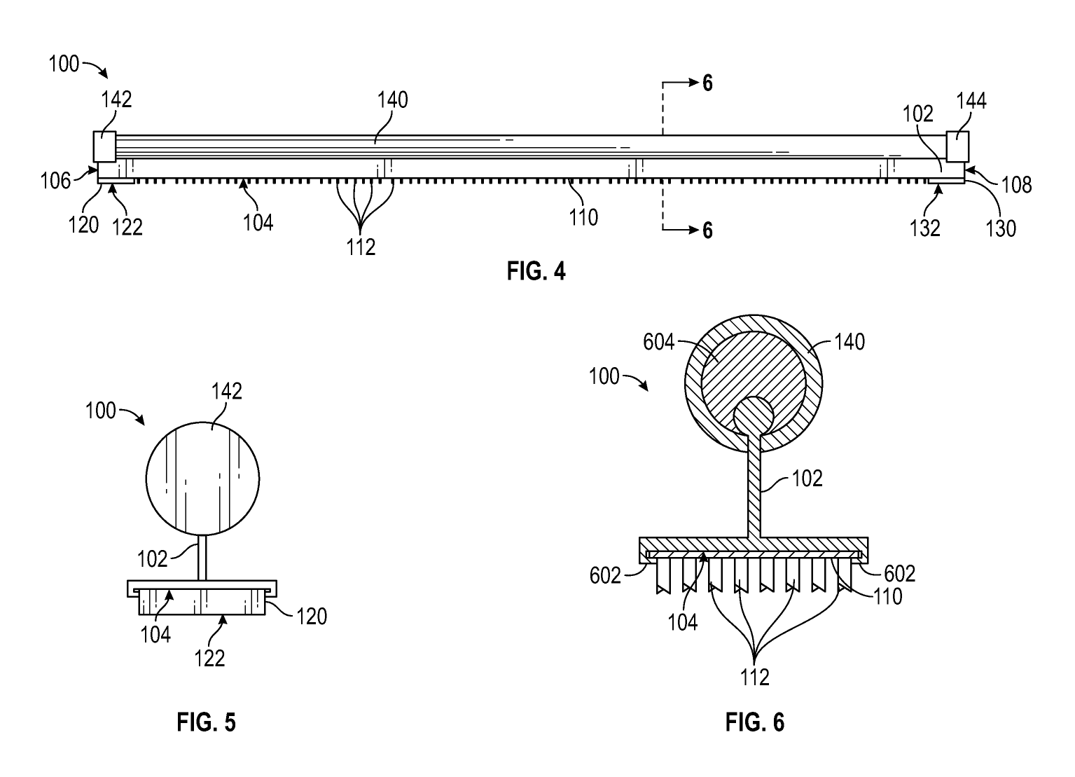

Referring to FIGS. 3-5, the embodiment of the tool 100 is depicted from additional views. As shown in FIG. 3, the handle 140 may run along the length of the tool 100 from the first end 106 of the frame 102 to the second end 108 of the frame 102. FIG. 4, illustrates the alignment of the first shoe 120 and the second shoe 130 with the multiple scraping teeth 112. As can be seen from FIG. 5, the shoe 120 is attached, or coupled, to the bottom 104 of the frame 102. The handle cap 142 provides a smooth termination for the handle 140.

Referring to FIG. 6, a cross-section taken from FIG. 4 at the reference point indicated is depicted. As may be seen in FIG. 6, the rasp grating 110 may be removable from the frame 102. For example, the frame 102 may include lips 602 on along the edges into which the rasp grating 110 may slide. During use, the rasp grating 110 may be retained by the lips 602. For removal, the rasp grating 110 may be slide out from the lips 602. In some embodiments, the first shoe 120, the second shoe 130, or both, may be removable to enable the rasp grating 110 to slide out.

As shown in FIG. 6, the handle 140 of the tool 100 may be a tube structure. In order to attach the handle 140 to the frame 102, a space inside the handle 140 may be filled with a filler material 604. In and embodiment, the filler material 604 includes a spray-type polyurethane with adhesive properties that hold the handle 140 in place. Other embodiments may exist. The rasp grating 110 includes a plurality of teeth 112 that extend from the rasp grating 110.

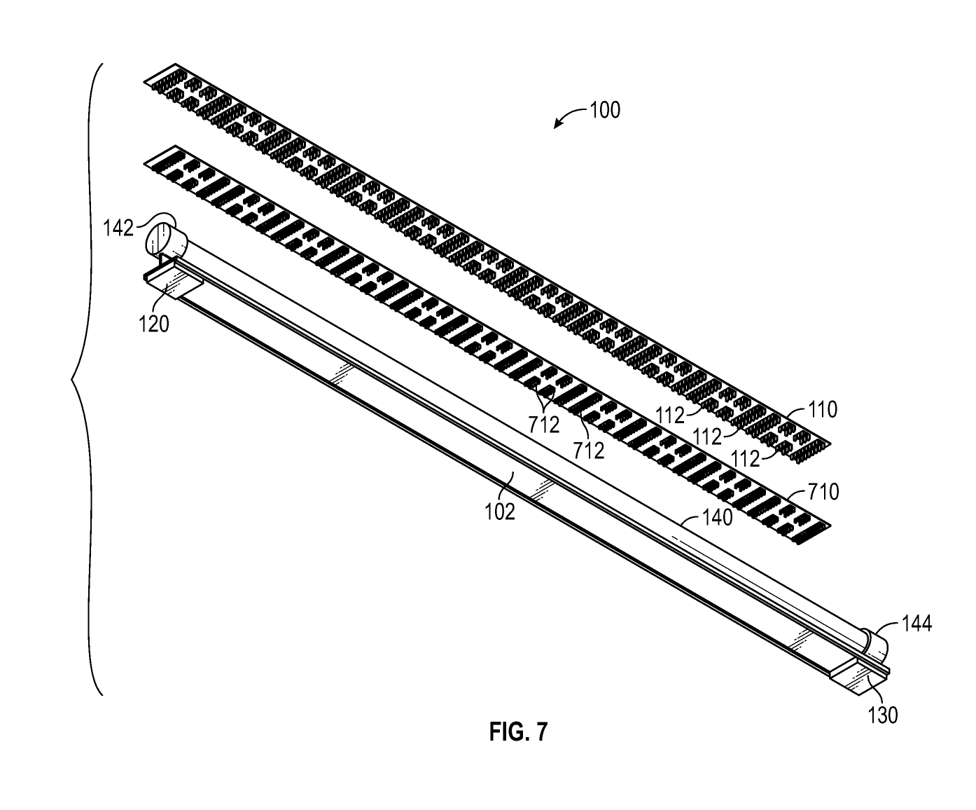

Referring to FIG. 7, in some embodiments, the tool 100 may include multiple interchangeable rasp gratings 110, 710. For example, the rasp grating 110 may be removed from the frame 102 and a second rasp grating 710 may be attached, or otherwise coupled, to the frame 102. In some embodiments, the multiple scraping tips 112 of the rasp grating 110 are longer and more sparsely located than multiple scraping tips 712 of the second rasp grating 710. In that way, the rasp grating 110 may be used for rough sanding and general shaping, while the second rasp grating 710 may be used for fine sanding and finishing. Additional interchangeable rasp gratings may also be included for various levels of sanding and finishing.

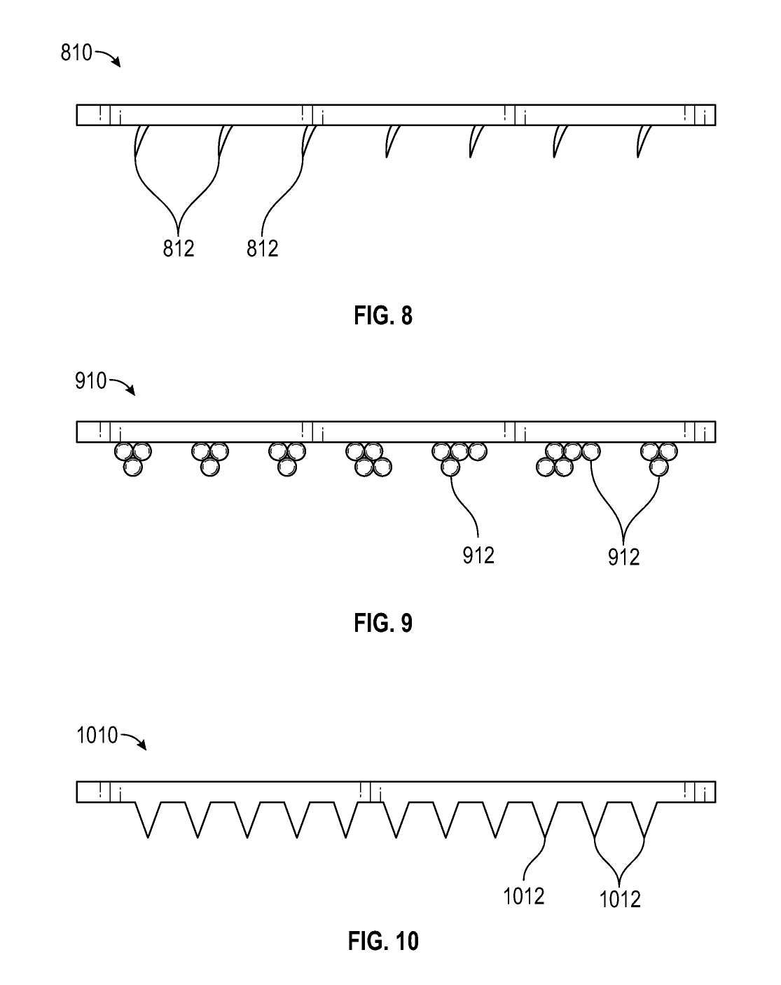

Referring to FIGS. 8-10, different embodiments of rasp gratings for use with the disclosure are depicted. FIG. 8 depicts an embodiment of a rasp grating 810 that is formed from punched sheet metal. In FIG. 8, a general design may be punched, or otherwise, etched into a sheet of metal. Then, multiple scraping teeth 812 may be bent downward.

FIG. 9 depicts an embodiment of a rasp grating 910 that includes scraping teeth 912 that are formed from grit particles. The grit particles may be accumulated in groups and held to the rasp grating 910 by a resin, or another type of adhesive. In some embodiments, the grit particles 912 may be substantially homogenously distributed rather than in groups. The size of the grit particles 912 may determine the roughness or fineness of the sanding quality.

FIG. 10 depicts an embodiment of a rasp grating 1010 that include multiple molded plastic teeth 1012. In FIG. 10, the rasp grating 1010 and the multiple teeth 1012 may be a single molded component. The plastic used may be sufficiently hard and durable to effectively sand a sanding surface. For example, the plastic may be sufficiently hard to scrape down EIFS foam used in building construction.

Although various embodiments have been shown and described, the present disclosure is not so limited and will be understood to include all such modifications and variations as would be apparent to one skilled in the art.

What is claimed is:

1. A hand rasp tool for sanding foam surfaces, the tool comprising:
a frame having a bottom, a first end, and a second end;
a rasp grating attached to the bottom of the frame between the first end and the second end, the rasp grating including multiple scraping teeth;
a first shoe, having a bottom surface, attached to the first end of the frame; and
a second shoe, having a bottom surface, attached to the second end of the frame, wherein the bottom surface of the first shoe and the bottom surface of the second shoe are coplanar with a tip of each of the multiple scraping teeth.

2. The hand rasp tool of claim 1, wherein the frame is formed from an extruded metal.

3. The hand rasp tool of claim 2, wherein the metal is selected from a group consisting of aluminum, steel, and titanium.

4. The hand rasp tool of claim 1, wherein the frame is formed from a molded plastic.

5. The hand rasp tool of claim 1, wherein the multiple scraping teeth of the rasp grating are formed from a material selected from a group consisting of punched sheet metal, grit particles, and molded plastic.

6. The hand rasp tool of claim 1, wherein the rasp grating is removable and interchangeable with a second rasp grating, the second rasp grating including multiple scraping tips.

7. The hand rasp tool of claim 6, wherein the multiple scraping tips of the rasp grating are longer and more sparsely located than the multiple scraping tips of the second rasp grating.

8. The hand rasp tool of claim 1, further comprising at least one handle coupled to the frame.

9. A method of forming a hand rasp tool for sanding foam surfaces, the method comprising:
providing a frame having a bottom, a first end, and a second end;
providing a rasp grating attachable to the bottom of the frame between the first end and the second end, the rasp grating including multiple scraping teeth;
providing a first shoe having a bottom surface, the first shoe being attachable to the first end of the frame; and
providing a second shoe having a bottom surface, the second shoe being attachable to the second end of the frame, wherein the bottom surface of the first shoe and the bottom surface of the second shoe are coplanar with a tip of each of the multiple scraping teeth when attached to the first and second end respectively.

10. The method of claim 9, further comprising:
providing extruded metal to form the frame.

11. The method of claim 10, wherein the metal is selected from a group consisting of aluminum, steel, and titanium.

12. The method of claim 9, further comprising:
providing molded plastic to form the frame.

13. The method of claim 9, further comprising:
punching sheet metal to form the rasp grating.

14. The method of claim 9, further comprising:
attaching grit particles to the rasp grating.

15. The method of claim 9, further comprising:
molding plastic to form the rasp grating.

16. The method of claim 9, further comprising:
removing the rasp grating and interchanging the rasp grating with a second rasp grating, the second rasp grating including multiple scraping tips.

17. The method of claim 16, wherein the multiple scraping tips of the rasp grating are longer and more sparsely located than the multiple scraping tips of the second rasp grating.

18. The method of claim 9, further comprising:
attaching at least one handle to the frame.

19. A hand rasp tool kit for sanding foam surfaces, the kit comprising:
a hand rasp tool comprising:
frame having a bottom, a first end, and a second end;
a first shoe, having a bottom surface, attached to the first end of the frame; and
a second shoe, having a bottom surface, attached to the second end of the frame;
a first rasp grating configured to attach to the bottom of the frame between the first end and the second end, the first rasp grating including multiple scraping teeth, wherein the bottom surface of the first shoe and the bottom surface of the second shoe are coplanar with a tip of each of the multiple scraping teeth of the first rasp grating when the first rasp grating is attached; and
a second rasp grating, interchangeable with the first rasp grating, configured to attach to the bottom of the frame between the first end and the second end, the second rasp grating including multiple scraping teeth, wherein the bottom surface of the first shoe and the bottom surface of the second shoe are coplanar with a tip of each of the multiple scraping teeth of the second rasp grating when the second rasp grating is attached.

20. The hand rasp tool kit of claim 19, wherein the multiple scraping tips of the first rasp grating are longer and more sparsely located than the multiple scraping tips of the second rasp grating.
